(19) United States
(12) Patent Application Publication
(10) Pub. No.: US 2009/0156220 A1
(43) Pub. Date: Jun. 18, 2009

(54) METHOD AND APPARATUS FOR HANDOVER IN MOBILE NETWORK, AND MOBILE TERMINAL THEREOF

(75) Inventors: Jeong Suk Bae, Daejeon (KR); Sook Yang Kang, Daejeon (KR); Gyung Chul Sihn, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/233,296

(22) Filed: Sep. 18, 2008

(30) Foreign Application Priority Data
Dec. 17, 2007 (KR) 10-2007-0132801

(51) Int. Cl. H04W 36/00

(52) U.S. Cl. 455/443

(57) ABSTRACT

A method and an apparatus for performing handover in a mobile communication network and a mobile communication terminal using the same are provided. The method of performing handover in a mobile communication network includes: receiving information about signal intensity of mobile networks to which a user terminal can be connected; selecting at least one of connectable mobile networks as a network for handover using user information including information about user requirement and information about the received signal intensity; requesting approval of handover of the user terminal to the selected network for handover and receiving result information about the approval request from the network for handover; and transmitting information about a network in which handover is approved among the networks for handover to the user terminal. Therefore, in consideration of user information such as service characteristics, a user service environment, and user requirement, by selecting a network for handover, a mobile communication network service having a performance and a cost suitable for user request can be provided.

### BACKGROUND OF THE INVENTION

1. Field of the Invention

The present invention relates to a method of performing handover in a mobile communication network in which a mobile communication terminal positioned at a region in which two or more mobile communication networks are overlapped selects an optimum network service and provides the optimum network service to a user.

This work was supported by the IT R & D program of MIC/IITA [2006-S-003-02, “Research on service platform for the nex generation mobile comm.”].

2. Description of the Related Art

Nowadays, a mobile communication network has an overlay network structure having an overlapped service area due to mixing of a mobile access network for high speed data communication, an existing wide-area cellular mobile access network, and a local area mobile access network.

In an overlay mobile communication network environment, in order to provide a ceaseless service to a user in an optimum network regardless of a user position, it is necessary to determine an optimum network among overlapped mobile communication networks and support handover for connecting to the optimum network.

### SUMMARY OF THE INVENTION

The present invention has been made in an effort to solve the above problems, and the present invention provides a method and an apparatus for performing handover and a mobile communication terminal using the same that can provide an optimum mobile communication network suitable for a user request.

According to an aspect of the present invention, there is provided a method of performing handover in a mobile communication network including: receiving information about signal intensity of a mobile network to which a user terminal can be connected; selecting at least one of connectable mobile networks as a network for handover using user information including information about user requirement and information about the received signal intensity; requesting approval of handover of the user terminal to the selected network for handover and receiving result information about the approval request from the network for handover; and transmitting information about a network in which handover is approved among the networks for handover to the user terminal.

According to another aspect of the present invention, there is provided an apparatus for performing handover in a mobile communication network including: a data reception unit that receives user information including information about user requirement and information about signal intensity of mobile networks to which a user terminal can be connected; a determination unit that selects at least one of connectable mobile networks using the received user information and signal intensity information as a network for handover; and a data transmission unit that requests approval of handover of the user terminal to the selected network for handover, wherein the data reception unit receives result information about the approval request from the network for handover, and the data transmission unit transmits information about a network in which handover is approved among the networks for handover to the user terminal.

According to another aspect of the present invention, there is provided a mobile communication terminal including: a signal intensity detection unit that detects signal intensity of connectable mobile networks; a comparison unit that compares signal intensity and a reference value of a currently connected mobile network and those of the connectable mobile networks; a data transmission and reception unit that transmits user information including information about mobile networks whose signal intensity is equal to or greater than a reference value and information about user requirement to a base station and that receives information about a network for handover selected according to the transmitted user information among the mobile networks; and a handover performing unit that performs handover to the selected network for handover.

According to another aspect of the present invention, there is provided a computer readable recording medium on which a program for executing the method in a computer is recorded.

### BRIEF DESCRIPTION OF THE DRAWING

FIG. 1 is a diagram illustrating an exemplary embodiment of a configuration in which a plurality of mobile networks are overlapped;

FIG. 2 is a block diagram illustrating a configuration of a network system according to an exemplary embodiment of the present invention;

FIG. 3 is a block diagram illustrating a configuration of a mobile communication terminal and a mobile network system according to an exemplary embodiment of the present invention;

FIG. 4 is a flowchart illustrating a first exemplary embodiment of a method of performing handover in a mobile communication network according to the present invention;

FIG. 5 is a flowchart illustrating a second exemplary embodiment of a method of performing handover in a mobile communication network according to the present invention; and

FIG. 6 is a flowchart illustrating an exemplary embodiment of a step of selecting a mobile network shown in FIG. 5.

### DETAILED DESCRIPTION OF THE PREFERRED EMBODIMENT

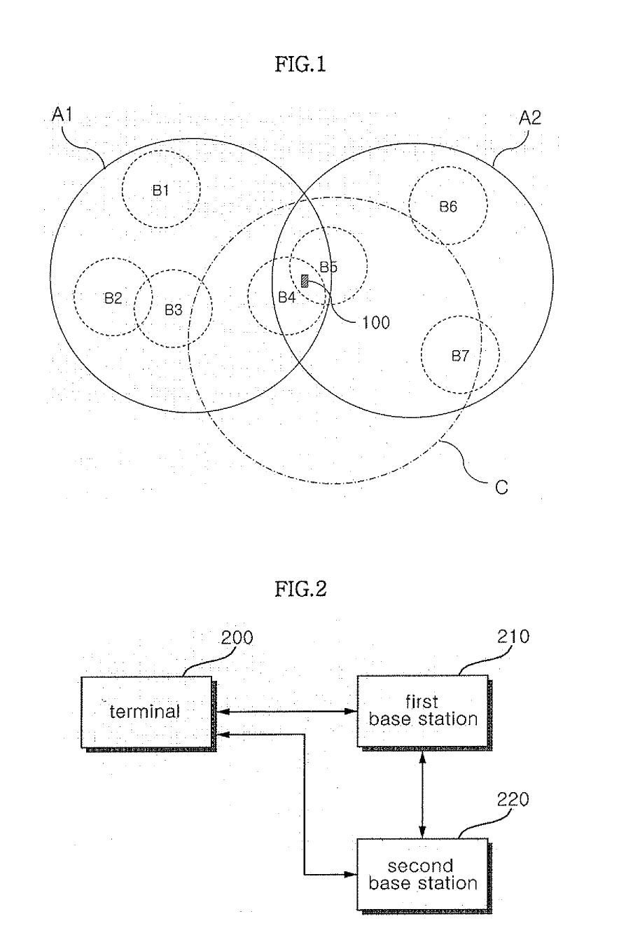

A method of performing handover in a mobile communication network and a mobile communication terminal using the same according to an exemplary embodiment of the present invention will be described in detail hereinafter with reference to FIGS. 1 to 6.

FIG. 1 is a diagram illustrating an exemplary embodiment of a configuration in which a plurality of mobile networks are overlapped.

Referring to FIG. 1, a plurality of mobile networks may be overlapped according to a position of a mobile network base station.

That is, a plurality of mobile networks (A, B, and C) to which different mobile network technology is applied may be overlapped and a plurality of mobile network cells belonging to one mobile network may be overlapped.

For example, as shown in FIG. 1, as 2 base stations for providing a mobile network A are positioned, a mobile network cell A1 and a mobile network cell A2 for providing the mobile network A may exist. Further, as 7 base stations for providing a mobile network B are positioned, 7 mobile network cells (B1, B2, B3, B4, B5, B6, and B7) for providing the mobile network A may exist. Further, as one base station for providing the mobile network C is positioned, a mobile network cell C for providing the mobile network C may exist.

The plurality of mobile networks may be a mobile communication network for high speed data transmission, a wide-area cellular network, and a local area mobile network (WLAN).

Referring to FIG. 1, in an area at which the mobile communication terminal 100 is positioned, a mobile network cell A1, a mobile network cell A1, a mobile network cell B4, a mobile network cell B5, and a mobile network cell C are overlapped and connected.

FIG. 2 is a block diagram illustrating a configuration of a network system according to an exemplary embodiment of the present invention, and a method of performing handover in a network system according to an exemplary embodiment of the present invention is described with reference to FIGS. 1 and 2.

Referring to FIG. 2, as a user moves, a mobile network to which the mobile communication terminal 200 can be connected and reception signal intensity of cells belonging to the mobile network can be changed.

The mobile communication terminal according to an exemplary embodiment of the present invention periodically detects reception signal intensity of connectable mobile network cells and transmits information about the detected signal intensity on a mobile network cell basis to a currently connecting first base station 210.

The first base station 210 selects mobile network cells for handover among the connectable mobile network cells using the transmitted signal intensity information and user information.

The signal intensity information on a mobile network cell basis may include cell information of each of mobile network cells and information about a network type of the mobile first base station 210 as well as reception signal intensity of each of the connectable mobile network cells, and the cell information may include information about a load of each of the mobile network cells or information about a providing bandwidth.

Further, the user information may include information about user requirement, a user service environment or a service cost, the user requirement information may include information about a user's network preference or a request bandwidth, and the user service environmental information may include information about a user average moving speed or characteristics of a using mobile network service.

In a method of performing handover according to the present invention, as described above, by selecting a mobile network cell for handover using user information as well as reception signal intensity of a mobile network cell, a mobile communication network service most suitable for a user using the mobile communication terminal 200 can be provided.

The first base station 210 requests approval of the corresponding mobile communication terminal 200 to a mobile network cell for handover selected by a priority order and transmits information about an approved mobile network cell for handover to the mobile communication terminal 200. The mobile communication terminal 200 performs handover to the second base station 220 corresponding to the mobile network cell for handover.

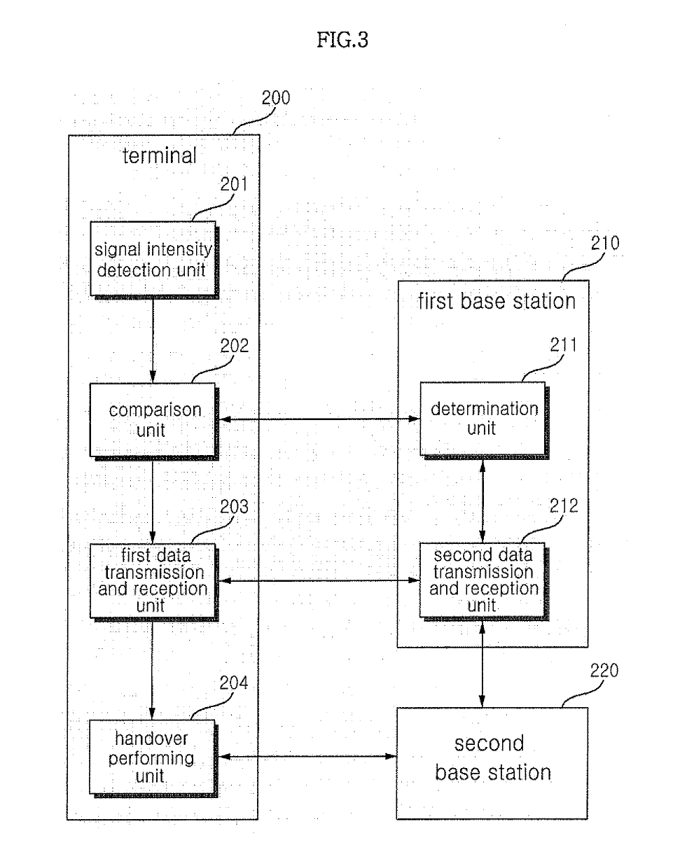

FIG. 3 is a block diagram illustrating a configuration of a mobile communication terminal and a mobile network system according to an exemplary embodiment of the present invention.

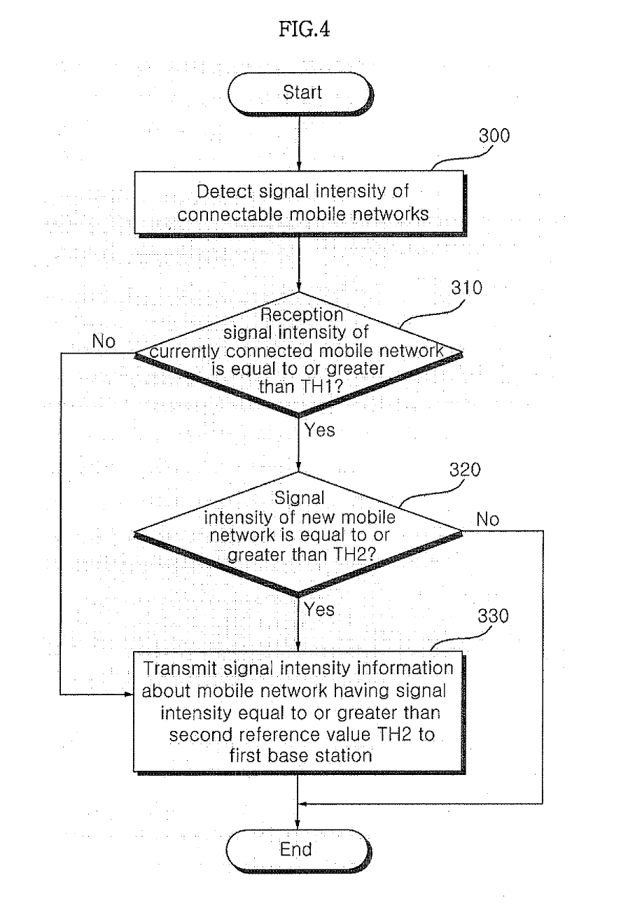

An operation of a mobile communication terminal according to an exemplary embodiment of the present invention shown in FIG. 3 is described using a flowchart illustrating a first exemplary embodiment of a method of performing handover in a mobile communication network according to the present invention shown in FIG. 4.

Referring to FIG. 3, the mobile communication terminal 200 may include a signal intensity detection unit 201, a comparison unit 202, a first data transmission and reception unit 203, and a handover performing unit 204.

The signal intensity detection unit 201 detects reception signal intensity of connectable mobile network cells in every predetermined detection period on a mobile network cell basis (S300). For example, in a structure shown in FIG. 1, the signal intensity detection unit 201 can detect reception signal intensity of each of a mobile network cell A1, a mobile network cell A1, a mobile network cell B4, a mobile network cell B5, and a mobile network cell C.

The signal intensity detection unit 201 activates a modem for connecting to the corresponding mobile network in every detection period and inactivates the connected modem after detecting the signal intensity, thereby reducing power consumption.

The comparison unit 202 compares the detected reception signal intensity on a mobile network cell basis with a preset reference value, and the first data transmission and reception unit 203 can transmit only signal intensity information about mobile network cells that provide signal intensity equal to or greater than the reference value to the currently connected first base station 210.

In an exemplary embodiment according to the present invention, the comparison unit 202 determines whether reception signal intensity of the currently connected mobile network cell is equal to or greater than a first reference value TH1 (S310).

If reception signal intensity of the currently connected mobile network cell is smaller than a first reference value TH1, the first data transmission and reception unit 203 transmits signal intensity information about mobile network cells having signal intensity equal to or greater than a preset second reference value TH2 to the first base station 210 (S330).

If reception signal intensity of the currently connected mobile network cell is equal to or greater than the first reference value TH1, the comparison unit 202 determines whether reception signal intensity of new mobile network cells except for the currently connected mobile network cell is equal to or greater than the second reference value TH1 (S320).

If reception signal intensity of new mobile network cells except for the currently connected mobile network cell is equal to or greater than the second reference value TH2, the first data transmission and reception unit 203 transmits signal intensity information about mobile network cells having signal intensity equal to or greater than the second reference value TH2 to the first base station 210 (S330).

When a new cell in which reception signal intensity of the currently connected mobile network cell is equal to or greater than the first reference value TH1 and the second reference value TH2 does not exist, handover is not performed and the currently connected mobile network is sustained.

The first reference value TH1 may be lowest signal intensity for performing a service, and the second reference value TH2 may be signal intensity for providing an optimum service. Accordingly, the first reference value TH1 is lowest signal intensity for performing a service and the second reference value TH2 may have a value higher than the first reference value TH1.

Table 1 represents an example of signal intensity information transmitted to the first base station 210.

TABLE 1

| mobile | mobile network | reception signal |
|---|---|---|
| network cell | type | intensity |
| A2 | CDMA | a |
| B5 | CFDM | b |
| C | WLAN | c |

Table 1 shows a configuration of signal intensity information of mobile network cells A2, C, and B5 having signal intensity equal to or greater than the second reference value TH2 among mobile network cells A1, A2, B4, B5, and C to which a terminal shown in FIG. 1 can be connected.

As shown in Table 1, signal intensity information transmitted to the first base station 210 may include cell information of each of mobile network cells, information about a mobile network type, and information about reception signal intensity.

For example, the mobile network cell A2 may be a mobile network of a code division multiple access (CDMA) type, the mobile network cell B5 may be a local area mobile communication network (WLAN), and the mobile network cell C may be a mobile network of an orthogonal frequency division multiple (CDMA) type.

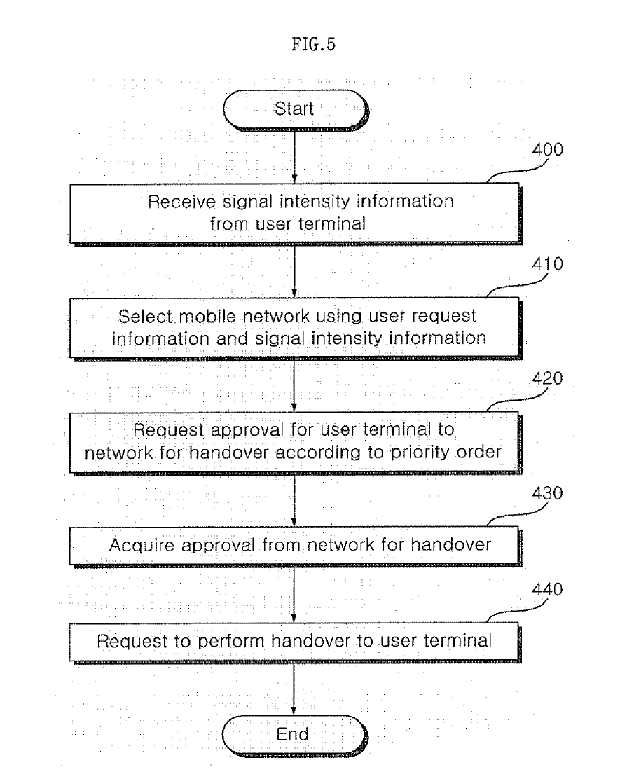

An operation of a mobile network system according to an exemplary embodiment of the present invention shown in FIG. 3 is described using a flowchart illustrating a second exemplary embodiment of a method of performing handover in a mobile communication network according to the present invention shown in FIG. 5.

Referring to FIG. 3, the first base station 210 to which the mobile communication terminal 200 is currently connected may include a determination unit 211 and a second data transmission and reception unit 212.

The second data transmission and reception unit 212 receives signal intensity information about a mobile network cell to which the mobile communication terminal 200 can be connected (S400).

As described above, the received signal intensity information may include information about mobile network cells that provide reception signal intensity equal to or greater than the second reference value TH2, and cell information of each of the mobile network cells, information about a mobile network type, and information about intensity of the reception signal.

The determination unit 212 selects at least one of connectable mobile network cells as a mobile network cell for handover using user information and signal intensity information about the received mobile network cell (S410).

The user information may include information about user requirement, a user service environment, or a service cost, the user requirement information may include information about a user's network preference or a request bandwidth, and the user service environmental information may include information about a user average moving speed or characteristics of a using mobile network service.

That is, the determination unit 212 may select at least one mobile network cell for handover suitable for the user by comparing a user's network preference, a request bandwidth, a user average moving speed, or characteristics of a using mobile network service with a load, reception signal intensity, or a providing bandwidth of a connectable mobile network cell.

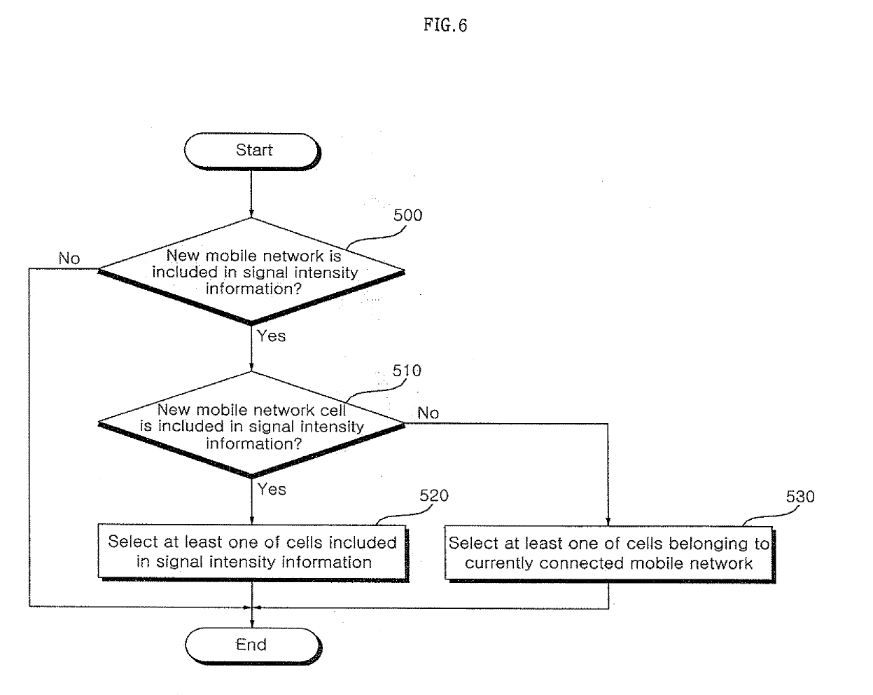

Referring to FIG. 6, a method of selecting a mobile network cell for handover at step 410 is described in detail.

The determination unit 212 determines whether information about a new mobile network cell different from a currently connected cell is included in the received signal intensity information (S500).

If information about a new mobile network cell is included in the received signal intensity information, at least one cell having a high service efficiency among all cells included in the received signal intensity information is selected based on user requirement, a user service environment, a cell state, a service cost, etc. and a priority order of the cells is given based on an efficiency of each cell (S520).

If information about a new mobile network cell is not included in the received signal intensity information, the determination unit 212 determines whether information about a new mobile network cell belonging to a currently connected mobile network is included in the received signal intensity information (S510).

If information about a new mobile network cell is included in the received signal intensity information, in order to prevent handover from being performed in unnecessary other mobile network schemes, the determination unit 212 selects at least one cell having a high service efficiency among cells belonging to a currently connected mobile network according to the user requirement, the user service environment, the cell state, the service cost, etc. (S530).

If information about a new mobile network cell is not included in the received signal intensity information, the determination unit 212 selects at least one cell having a high service efficiency among all cells included in the received signal intensity information based on the user requirement, the user service environment, the cell state, the service cost, etc. (S520).

In general, the wide-area cellular network has an advantage of having a wide service area of several Km to several tens Kms, but has a defect of a relatively low data transmission speed of 2 Mbps or less and an expensive service fee. However, a local area mobile network (WLAN) has an advantage of a high data transmission speed of 11 to 54 Mbps and a low service fee, but has a defect that a service area is limited to several tens meter, compared with the wide-area cellular network.

Therefore, the determination unit 212 compares characteristics of the mobile network and the user information and selects a mobile network most suitable for a user.

The second data transmission and reception unit 212 requests approval for the corresponding mobile communication terminal 200 from a top-level order cell of the selected mobile network cells (S420).

The second data transmission and reception unit 212 receives information about an approval result for the approval request from the requested cells and determines an approved mobile network cell as a cell for performing handover (S440).

If a cell determined as a cell for handover belongs to a mobile network different from the currently connected mobile network, the second data transmission and reception unit 212 transmits information about the cell for handover to the mobile communication terminal 200 and allows to perform vertical handover (S450).

If a cell determined as a cell for handover belongs to a mobile network identical to the currently connected mobile network, the second data transmission and reception unit 212 transmits information about the corresponding cell for handover to the mobile communication terminal 200 and allows to perform horizontal handover (S450).

The present invention may be also implemented with computer readable codes in a computer readable recording medium. The computer readable recording medium may include all kinds of recording devices in which data that can be read by a computer system are stored. The computer readable recording medium may include, for example a ROM, a RAM, a CD-ROM, a magnetic tape, a floppy disk, and an optical data storage device. In addition, the computer readable recording medium may also include implementations in the form of carrier waves (e.g. transmission via Internet). Further, the computer readable recording medium is distributed to a computer system connected to a network and the computer readable codes may be stored and executed therein in a distributed manner.

According to a method of performing handover of the present invention, in consideration of user information such as service characteristics, a user service environment, and user requirement, by selecting a network for handover, a mobile communication network service having a performance and a cost suitable for a user request can be provided.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of performing handover in a mobile communication network, comprising:
receiving information about signal intensity of mobile networks to which a user terminal can be connected;
selecting at least one of connectable mobile networks as a network for handover using user information including information about user requirement and information about the received signal intensity;
requesting approval of handover of the user terminal to the selected network for handover and receiving result information about the approval request from the network for handover; and
transmitting information about a network in which handover is approved among the networks for handover to the user terminal.

2. The method of claim 1, wherein the signal intensity information comprises information about mobile networks whose signal intensity is a reference value or more among connectable mobile networks.

3. The method of claim 3, wherein the signal intensity information comprises information about mobile network cells that provide signal intensity of a reference value or more.

4. The method of claim 1, wherein the requesting of approval of handover comprises sequentially requesting approval of handover according to a preset priority order to the networks for handover.

5. The method of claim 1, wherein the information about user requirement comprises information about at least one of the user's network preference and the user's request bandwidth.

6. The method of claim 1, wherein the user information comprises at least one of information about a service environment of the user terminal and information about a service cost.

7. The method of claim 1, wherein the selecting of at least one of connectable mobile networks comprises selecting at least one of all mobile network cells included in the signal intensity information as a network for handover, when information about a mobile network different from a currently connected mobile network is included in the received signal intensity information.

8. The method of claim 1, wherein the selecting of at least one of connectable mobile networks comprises selecting at least one of mobile network cells that belong to a currently connected mobile network as a network for handover, when only information about a mobile network cell that belongs to a currently connected mobile network and that is different from a currently connected mobile network cell is included in the received signal intensity information.

9. The method of claim 1, wherein the selecting of at least one of connectable mobile networks comprises selecting at least one of all mobile network cells that belong to connectable mobile networks as a network for handover, when only information about a currently connected mobile network cell is included in the received signal intensity information.

10. An apparatus for performing handover in a mobile communication network, comprising:
a data reception unit that receives user information including information about user requirement and information about signal intensity of mobile networks to which a user terminal can be connected;
a determination unit that selects at least one of connectable mobile networks using the received user information and signal intensity information as a network for handover; and
a data transmission unit that requests approval of handover of the user terminal to the selected network for handover,
wherein the data reception unit receives result information about the approval request from the network for handover, and the data transmission unit transmits information about a network in which handover is approved among the networks for handover to the user terminal.

11. The apparatus of claim 10, wherein the signal intensity information comprises information about mobile networks whose signal intensity is a reference value or more among connectable mobile networks.

12. The apparatus of claim 10, wherein the data transmission unit sequentially requests approval of handover according to a preset priority order to the networks for handover.

13. The apparatus of claim 10, wherein the information about user requirement comprises information about at least one of the user's network preference and the user's request bandwidth.

14. The apparatus of claim 10, wherein the user information comprises at least one of information about a service environment of the user terminal and information about a service cost.

15. A mobile communication terminal comprising:
a signal intensity detection unit that detects signal intensity of connectable mobile networks;
a comparison unit that compares signal intensity and a reference value of a currently connected mobile network and those of the connectable mobile networks;
a data transmission and reception unit that transmits user information including information about mobile networks whose signal intensity is equal to or greater than a reference value and information about user requirement to a base station and that receives information about a network for handover selected according to the transmitted user information among the mobile networks; and
a handover performing unit that performs handover to the selected network for handover.

16. The mobile communication terminal of claim 15, wherein the comparison unit comprises:
a first comparison unit that compares signal intensity of the currently connected mobile network with a first reference value; and
a second comparison unit that compares signal intensity of connectable mobile networks with a second reference value.

17. The mobile communication terminal of claim 16, wherein the first reference value is smaller than the second reference value.

18. The mobile communication terminal of claim 16, wherein the data transmission and reception unit transmits information about a network whose signal intensity is greater than the second reference value among connectable mobile networks to the base station.

19. The mobile communication terminal of claim 16, wherein connection to the currently connected mobile network is sustained, when signal intensity of the currently connected mobile network is greater than the first reference value and signal intensity of the connectable mobile networks is smaller than the second reference value.

20. The mobile communication terminal of claim 15, wherein the user information comprises at least one of information about a service environment of the user terminal and information about a service cost, and the information about user requirement comprises information about at least one of the user's network preference and the user's request bandwidth.
